(19) United States
(12) Patent Application Publication
(10) Pub. No.: US 2009/0192828 A1
(43) Pub. Date: Jul. 30, 2009

(54) METHOD OF MANAGING INSURANCE DATA

(75) Inventors: Daniel T. Yunker, Batavia, IL (US); Larry Mattingly, Hampshire, IL (US); Deanie Reilly, Chicago, IL (US); Monica Katz, Barrington, IL (US); Deborah Sledge, Chicago, IL (US)

Correspondence Address: HOLLAND & KNIGHT LLP, 10 ST. JAMES AVENUE, BOSTON, MA, 02116-3889, US

(73) Assignee: Metropolitan Chicago Healthcare Council, Chicago, IL (US)

(21) Appl. No.: 12/021,362

(22) Filed: Jan. 29, 2008

(51) Int. Cl. G06Q 40/00

(52) U.S. Cl. 705/4

(57) ABSTRACT

A method for insurance data management including accessing employee insurance enrollment data. Claims cost data may be accessed for employee claims. The claims cost data for employee claims may be reconciled with the employee insurance enrollment data. At least one insurance data report may be generated.

### FIELD OF THE INVENTION

The present disclosure relates to managing insurance data, and more specifically to managing and reconciling insurance enrollment and claims data.

### BACKGROUND

Employers often contract with an insurance company to provide health insurance benefits for a company's employees. While the employer may maintain access to employee enrollment information in the insurance plans provided by the insurance company, the employer often does not have access to the claims cost data related to each employee nor does the employer have a simple method of tracking enrollees by billing number, group or section assignments.

Managing employee enrollment data and claims cost data is often a complicated process, which may be complicated further when the insurance plan involves a pre-funded insurance trust. Thus, there exists a need for a method of managing and reconciling insurance data across multiple employers participating in the Trust or Insurance Captive.

### SUMMARY

In a first implementation, a method includes accessing employee insurance enrollment data. Claims cost data is accessed for employee claims. The claims cost data for employee claims is reconciled with the employee insurance enrollment data. At least one insurance data report may be generated.

One or more of the following features may be included. The employee insurance enrollment data may include at least one of employee identification information, employee plan participation information, employee plan coverage information, individual employee stop loss amounts, and employee claims totals. Accessing employee insurance enrollment data may include accessing employee insurance enrollment data according to one or more of employee gender, employee age, employee spouse information, employee dependant count, and employee insurance plan coverage information.

The claims cost data for employee claims may include at least one of claimant identification information, submitted claim amounts, paid-out claim amounts and plan payment information.

Reconciling the claims cost data for employee claims with the employee insurance enrollment data may include comparing the employee insurance enrollment data with the claims cost data for employee claims and determining whether the claims cost data for employee claims corresponds to the employee insurance enrollment data. If the claims cost data for employee claims does not correspond to the employee insurance enrollment data, an employer may be notified of an insurance claims error.

A predictive model for claims exposure based upon the employee insurance enrollment data and the claims cost data for employee claims may be calculated. The claims cost data for employee claims may be audited.

Employer benefit plan data and employer location data may be accessed and the claims cost data for employee claims may be reconciled with the employer benefit plan data and employer location data. Insurance trust administration data may be accessed. The claims cost data for employee claims may be reconciled with the insurance trust administration data.

A consolidated database may be built containing the employee insurance enrollment data and the claims cost data for employee claims for a plurality of employees.

The at least one insurance data report may include at least one of an employee insurance enrollment data report, a claims cost data report, a prefunding report, a claims exposure prediction report, a trust administration report, and a claim reconciliation report.

According to another implementation, a computer program product resides on a computer readable medium having a plurality of instructions stored thereon. When executed by a processor, the instructions cause the processor to perform operations including accessing employee insurance enrollment data. The instructions also cause the processor to access claims cost data for employee claims. The claims cost data for employee claims is reconciled with the employee insurance enrollment data. The instructions further cause the processor to generate at least one insurance data report.

One or more of the following features may be included. The employee insurance enrollment data may include at least one of employee identification information, employee plan participation information, employee plan coverage information, individual employee stop loss amounts, and employee claims totals. The instructions for accessing employee insurance enrollment data may include instructions for accessing employee insurance enrollment data according to one or more of employee gender, employee age, employee spouse information, employee dependant count, and employee insurance plan coverage information. The claims cost data for employee claims may include at least one of claimant identification information, submitted claim amounts, paid-out claim amounts and plan payment information.

Reconciling the claims cost data for employee claims with the employee insurance enrollment data may include instructions for comparing the employee insurance enrollment data with the claims cost data for employee claims and determining whether the claims cost data for employee claims corresponds to the employee insurance enrollment data. If the claims cost data for employee claims does not correspond to the employee insurance enrollment data, an employer may be notified of an insurance claims error.

A predictive model for claims exposure based upon the employee insurance enrollment data and the claims cost data for employee claims may be calculated. The claims cost data for employee claims may be audited.

The instructions may further cause the processor to access employer benefit plan data and employer location data. The claims cost data for employee claims may be reconciled with the employer benefit plan data and employer location data. The instructions may further cause the processor to access insurance trust administration data and the claims cost data for employee claims may be reconciled with the insurance trust administration data.

Instructions may be included for building a consolidated database containing the employee insurance enrollment data and the claims cost data for employee claims for a plurality of employees.

The at least one insurance data report may include at least one of an employee insurance enrollment data report, a claims cost data report, a prefunding report, a claims exposure prediction report, a trust administration report, and a claim reconciliation report.

The details of one or more implementations are set forth in the accompanying drawings and the description below. Other features and advantages will become apparent from the description, the drawings, and the claims.

### BRIEF DESCRIPTION OF THE DRAWINGS

FIG. 1 diagrammatically depicts an insurance data management process coupled to a distributed computing network.

FIG. 2 is a flowchart of a process executed by the insurance data management process of FIG. 1.

### DETAILED DESCRIPTION

### System Overview

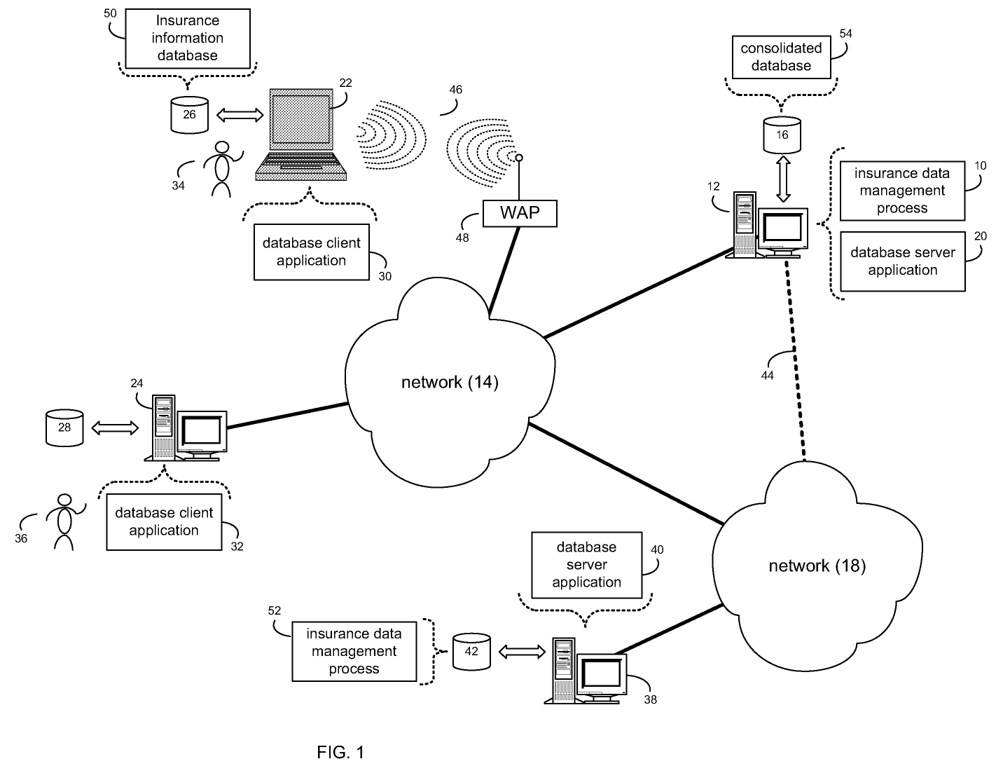

Referring to FIG. 1, there is shown insurance data management process 10 that may reside on and may be executed by server computer 12, which may be connected to network 14 (e.g., the Internet or a local area network). Examples of server computer 12 may include, but are not limited to: a personal computer, a server computer, a series of server computers, a mini computer, and a mainframe computer. Server computer 12 may be a web server (or a series of servers) running a network operating system, examples of which may include but are not limited to: Microsoft Windows Vista™, Microsoft Windows 2000™ or Microsoft Windows XP Server™; Novell Netware™; or Redhat Linux™, for example. Alternatively, insurance data management process 10 may reside on a client electronic device, such as a personal computer, notebook computer, personal digital assistant, or the like. As will be discussed below in greater detail, insurance data management process 10 may enable a user to access employee insurance enrollment data and claims cost data for employee claims. Insurance data management process 10 may reconcile the claims cost data for employee claims with the employee insurance enrollment data and an insurance data report may be generated.

The instruction sets and subroutines of insurance data management process 10, which may be stored on storage device 16 coupled to server computer 12, may be executed by one or more processors (not shown) and one or more memory architectures (not shown) incorporated into server computer 12. Storage device 16 may include but is not limited to: a hard disk drive; a tape drive; an optical drive; a RAID array; a random access memory (RAM); and a read-only memory (ROM).

Server computer 12 may execute a web server application, examples of which may include but are not limited to: Microsoft IIS™, Novell Webserver™, or Apache Webserver™, that allows for HTTP (i.e., HyperText Transfer Protocol) access to server computer 12 via network 14. Network 14 may be connected to one or more secondary networks (e.g., network 18), examples of which may include but are not limited to: a local area network; a wide area network; or an intranet, for example.

Server computer 12 may additionally execute one or more database server applications (e.g., database server application 20), examples of which may include but are not limited to database server applications (e.g., Oracle™, Microsoft SQL Server™, and IBM DB2™,) Insurance data management process 10 may be a stand alone application that interfaces with database server application 20 or may be an applet/application that is executed within database server application 20.

The instruction sets and subroutines of database server application 20, which may be stored on storage device 16 coupled to server computer 12, may be executed by one or more processors (not shown) and one or more memory architectures (not shown) incorporated into server computer 12.

As mentioned above, in addition/as an alternative to being a server-based application residing on server computer 12, insurance data management process 10 may be a client-side application (not shown) residing on one or more client electronic devices 22, 24 (e.g., stored on storage device 26, 28, respectively). As such, insurance data management process 10 may be a stand alone application that interfaces with database client application 30, 32 (e.g., Microsoft Access™ and FileMaker Pro™), or database server application 20 (e.g., via network 14, 18) or may be an applet/application that is executed within database client application 30, 32. As such, the insurance data management process 10 may be a client-side process, a server-side process, or a hybrid client-side/server-side process, which may be executed, in whole or in part, by server computer 12, or one or more of client electronic device 22, 24.

The instruction sets and subroutines of database client applications 30, 32, which may be stored on storage devices 26, 28 (respectively) coupled to client electronic devices 22, 24 (respectively), may be executed by one or more processors (not shown) and one or more memory architectures (not shown) incorporated into client electronic devices 22, 24 (respectively). Storage devices 26, 28 may include but are not limited to: hard disk drives; tape drives; optical drives; RAID arrays; random access memories (RAM); read-only memories (ROM), compact flash (CF) storage devices, secure digital (SD) storage devices, and a memory stick storage devices. Examples of client electronic devices 22, 24 may include, but are not limited to, personal computer 24, and laptop computer 22, for example. Using database client applications 30, 32, users 34, 36 may access data stored in one or more databases on database servers. Accessing data stored in databases may include accessing database server application 20.

Additional server computers may be connected to network 14,18 (e.g., database server 38 coupled to network 18). Examples of database server 38 may include, but are not limited to: a personal computer, a server computer, a series of server computers, a mini computer, and a mainframe computer. Database server 38 may be a web server (or a series of servers) running a network operating system, examples of which may include but are not limited to: Microsoft Windows XP Server™; Novell Netware™; or Redhat Linux™, for example. Database server 38 may also execute a web server application, examples of which may include but are not limited to: Microsoft IIS™, Novell Webserver™, or Apache Webserver™, that allows for HTTP (i.e., HyperText Transfer Protocol) access to database server 38 via network 14 and/or network 18.

Database server 38 may additionally execute one or more database server applications (e.g., database server application 40), examples of which may include but are not limited to database server applications (e.g., Oracle™, Microsoft SQL Server™, and IBM DB2™,). The instruction sets and subroutines of database server application 40, which may be stored on storage devices 42 coupled to database server 38, may be executed by one or more processors (not shown) and one or more memory architectures (not shown) incorporated into database server 38. Storage device 42 may include but is not limited to: hard disk drives; tape drives; optical drives; RAID arrays; random access memories (RAM); read-only memories (ROM), compact flash (CF) storage devices, secure digital (SD) storage devices, and a memory stick storage devices.

Users 34, 36 may access database server application 20, 40 directly through the device on which the database client application (e.g., database client applications 30, 32) is executed, namely client electronic devices 22, 24, for example. Users 34, 36 may access database server application 20, 40 directly through network 14 or through secondary network 18. Further, server computer 12 (i.e., the computer that executes database server application 20) and/or database server 38 may be connected to network 14 through secondary network 18 (e.g., as illustrated with phantom link line 44 for server computer 12).

The various client electronic devices may be directly or indirectly coupled to network 14 (or network 18). For example, personal computer 24 is shown directly coupled to network 14 via a hardwired network connection. Laptop computer 22 may be wirelessly coupled to network 14 via wireless communication channel 46 established between laptop computer 22 and a wireless access point (i.e., WAP) 48, directly coupled to network 14. WAP 48 may be, for example, an IEEE 802.11a, 802.11b, 802.11g, Wi-Fi, and/or Bluetooth device that is capable of establishing wireless communication channel 46 between laptop computer 22 and WAP 48.

As is known in the art, all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

Client electronic devices 22, 24 may each execute an operating system, examples of which may include but are not limited to Microsoft Windows™, Microsoft Windows CE™, Redhat Linux™, or a custom operating system.

### Insurance Data Management Process

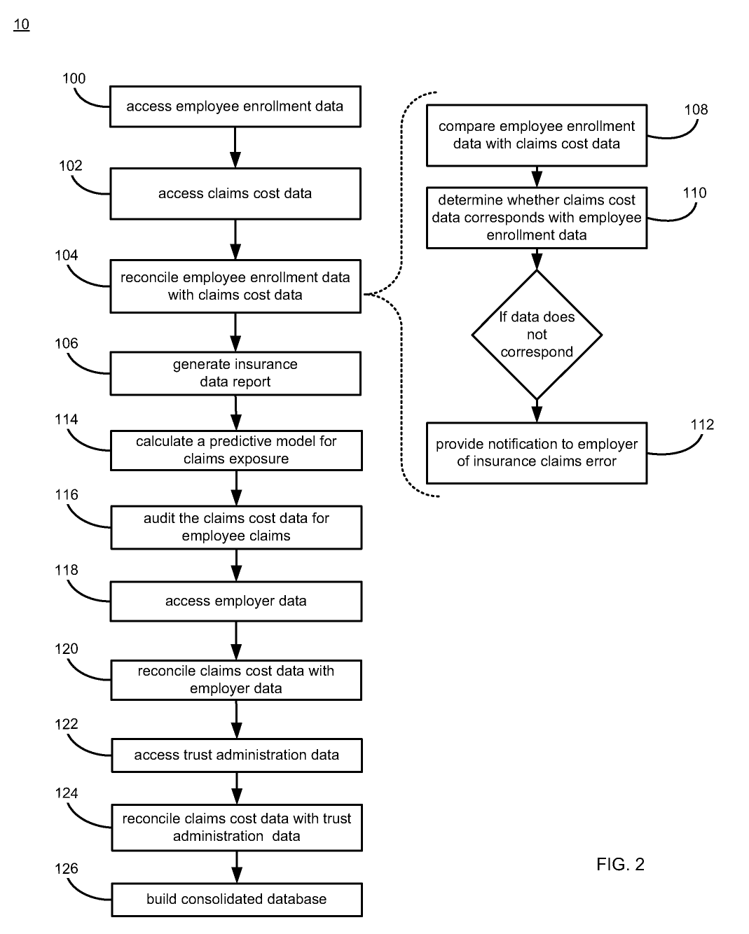

Referring also to FIG. 2, as mentioned above insurance data management process 10 may access 100 employee insurance enrollment data. Insurance data management process 10 may also access 102 claims cost data for employee claims. Additionally, insurance data management process 10 may reconcile 104 the claims cost data for employee claims with the employee insurance enrollment data. Insurance data management process 10 may generate 106 at least one insurance data report.

For example, insurance data management process 10 may access 100, for example, via one or more of networks 14, 18, employee insurance enrollment data directly from an employer maintained database (e.g., from employer maintained insurance information database 50 residing on storage device 26 of client electronic device 22). Additionally/alternatively, the insurance enrollment data may have been provided to one or more third party, e.g., one or more third party insurance provider. In such a case, insurance data management process 10 may access 100 (e.g., via one or more of networks 14, 18) the employee insurance enrollment data from one or more third party insurance provider databases (e.g., insurance information database 52 residing on storage device 42 coupled to database server 38), which may have received the employee insurance enrollment data from the employer.

The employee insurance enrollment data may include, for example, one or more of employee identification information, employee plan participation information, employee plan coverage information, individual employee stop loss amounts, and employee claims totals. The employee identification information may include, for example, the employee's name, gender, age, spouse information, dependent information, address, phone number, social security number, employee identification number and any other personal identification information about the employee. The employee plan participation information may include, for example, information about the specific insurance plan that the employee is enrolled in and whether the employee has dependents enrolled in the insurance plan. The employee plan coverage information may include, for example, information regarding the amount and type of coverage the employee is eligible for under the insurance plan in which he is enrolled, e.g., including information about co-pays for which the employee might be responsible. The individual employee stop loss amounts may include information regarding an amount in claims, which, if exceeded, may trigger the employee's responsibility for paying for his healthcare expenses. The employee claims totals may include, for example, information regarding the total amount in claims that have been paid out by the third party insurance provider for employee medical, dental, and/or other treatment covered by the insurance plan in which the employee is enrolled.

The employee insurance enrollment data may be accessed according to one or more of employee gender, employee age, employee spouse information, employee dependant count, and employee insurance plan coverage information. For example, the employee insurance enrollment data may be information that is provided by an employee to his/her employer for the purpose of enrolling in the employer's insurance plan. Accessing the employee insurance enrollment data based upon any one or more of employee gender, employee age, employee spouse information, employee dependant count, and employee insurance plan coverage information may enable tracking, analysis and reporting of statistics based upon such distinctions in employee insurance enrollment data.

Insurance data management process 10 may access 102 claims cost data for employee claims. Claims cost data for employee claims may be the amounts paid out by the one or more third party insurance providers for employee medical, dental or other treatment covered by the insurance plan in which each employee is enrolled. The claims cost data may be generated by the one or more third party insurance providers and may reside in a database (e.g., insurance information database 52 residing on storage device 42 coupled to database server 38) maintained by the one or more third party insurance providers. Additionally/alternatively, claims cost data may reside in a separate claims cost database (not shown) maintained by the one or more third party insurance providers. Insurance data management process 10 may access 102 the claims cost data for employee claims (e.g., insurance information database 52) through one or more of networks 14, 18. Access 102 to the claims cost data for employee claims (e.g., residing in insurance information database 52) by insurance data management process 10 may be granted based upon, at least in part, prearranged permissions, e.g., which may be utilized for safeguarding insurance information database 52. Claims cost data may be reported by a variety of dimensions including coverage, inpatient or outpatient plan group and section designation.

The claims cost data for employee claims may include, for example, one or more of claimant identification information, submitted claim amounts, paid-out claim amounts and plan payment information. The claimant identification information may include, for example, the claimant's name, address, telephone number, social security number, insurance plan identification and group number and any other personally identifiable information about the claimant. The submitted claim amounts include, for example, amounts submitted by a healthcare provider to the claimant's third party insurance provider. The paid-out claim amounts may include, for example, the amounts paid out by the claimant's third party insurance provider to the healthcare provider for the submitted claims. The plan payment information may include, for example, claimant co-pay information, amounts paid out for claimant claims in the past under claimant's insurance plan, and/or the amount of claim payment coverage that claimant is entitled to under the claimant's insurance plan.

Insurance data management process 10 may reconcile 104 the claims cost data for employee claims with the employee insurance enrollment data. The claims cost data for employee claims may be, for example, reconciled monthly, quarterly or annually with monthly prefunded trust amounts. For example, an employer may want to make sure that its employees' claims are being paid under the correct plan (i.e., the insurance plan in which the employee is enrolled through the employer), that employee stop loss amounts have not been exceeded, and/or that the correct amounts have been withdrawn from a pre-funded insurance trust that the employer may have established. Generally, the claims cost data may be consistent with the employee insurance enrollment data for properly paid out insurance claims. Reconciling 104 the claims cost data (e.g., which may include the third party insurance provider's record of claims and claimants) with the employer's employee insurance enrollment data may help determine whether the two data sets are consistent with each other. As such, reconciling 104 the claims cost data with the employer's employee insurance enrollment data may aid in determining if insurance claims have been paid out by the third party insurance provider consistent with employee insurance plan enrollment.

In reconciling 104 the claims cost data for employee claims with the employee insurance enrollment data, insurance data management process 10 may compare 108 the employee insurance enrollment data with the claims cost data for employee claims and determine 110 whether the claims cost data for employee claims corresponds to the employee insurance enrollment data. Comparing 108 these two data sets may enable insurance data management process 10 to determine 110 whether the claims cost data is consistent with the employee enrollment data. For example, the employee identification information should be consistent with the claimant identification information; and the employee claims totals should be consistent with the paid-out claim amounts. If the claims cost data for employee claims does not correspond to the employee insurance enrollment data, an employer may be notified 112 of an insurance claims error. For example, if there is any mismatch in the data between the employee insurance enrollment data and the claims cost data, it may signal that there has been some error such as a claim being covered under the wrong plan.

Insurance data management process 10 may generate 106 at least one insurance data report. The at least one insurance data report may be generated from different analytical perspectives. The at least one insurance data report may include, for example, one or more of an employee insurance enrollment data report, a claims cost data report, a prefunding report, a claims exposure prediction report, a trust administration report, and/or a claim reconciliation report. The employee insurance enrollment data report may include, for example, current enrollment information for some or all of the employer's employees. Additionally/alternatively, the employee insurance enrollment data report may include enrollment information for new employees and/or employees who have changed their enrollment information. The claims cost data report may include, for example, information regarding the amounts of claims that have been paid out by each of one or more third party insurance providers with which the employer may contract for insurance coverage, and for which employees those claims have been paid. The prefunding report may include, for example, information regarding one or more pre-funded insurance plan maintained by the employer and/or the amount of prefunding for those plans. The claims exposure prediction report may include, for example, claims cost predictions for a future time period based upon current enrollment data and past claims cost data for a similar time period. The trust administration report may include, for example, information regarding the management of one or more trust accounts for one or more of the employer's pre-funded insurance plans. Additionally/alternatively, the trust administration report may include amounts that have been withdrawn from such trust accounts for the payment of claims. The claim reconciliation report may include, for example, information regarding the reconciliation 104 of claims cost data with employee insurance enrollment data (e.g., whether those two data sets are consistent with each other, any discrepancies, etc.).

Insurance data management process 10 may calculate 114 a predictive model for claims exposure based upon, at least in part, the employee insurance enrollment data and the claims cost data for employee claims. For example, insurance data management process 10 may use past and present employee enrollment data and past claims cost data for employee claims to predict claims exposure for future time periods, such as months and/or quarters, based upon claims cost data for employee claims for similar past time periods.

Insurance data management process 10 may audit 116 the claims cost data for employee claims. For example, claims cost data for high cost claims may be audited to insure stop loss credit application. Similarly, claims reported under multiple user identifications may be audited. For example, an insured dependent's claims may be reported under the insured dependent's name, as well as under the insured parent's name, and even additionally under employer group information. The multiple reports relating to the particular claims cost data may be audited to determine whether the claim is being submitted for the correct party, under the correct plan and that that party is in fact insured.

Insurance data management process 10 may access 118 employer benefit plan data and employer location data from one or more databases (e.g., insurance information database 50) and the claims cost data for employee claims (e.g., from one or more of insurance information databases 50, 52, and or other databases; not shown). Insurance management process 10 may reconcile 120 the claims cost data for employee claims with the employer benefit plan data and employer location data. For example, an employer's benefits plan may vary from location to location depending upon, e.g., state insurance laws and provider coverage in each state. Reconciling 120 employee claims cost data with employer benefit plan data and employer location data may help, for example, to determine whether the coverage that an employee received is consistent with the coverage he should have received based upon the location he works at for the employer and the plan he is enrolled in through the employer.

Insurance data management process 10 may access 122 insurance trust administration data (e.g., which may reside in one or more database, such as insurance information database 50 and/or insurance information database 52). The claims cost data for employee claims may be reconciled 124 with the insurance trust administration data. For example, for pre-funded insurance plans the funds may be held in trust, and may be drawn on as claims are paid out by the third party insurance provider. In the event that an error is made in withdrawing those funds resulting in, for example, more or less being withdrawn than necessary, reconciling 124 the claims cost data for employee claims with the insurance trust administration data may reveal any discrepancy and may enable a determination of where and when the error occurred.

Insurance data management process 10 may build 126 a consolidated database (e.g., consolidated database 54 residing on storage device 16 coupled to server computer 12). Consolidated database 54 may contain, for example, the employee insurance enrollment data and the claims cost data for employee claims for a plurality of employees. Building 122 consolidated database 54 may include populating, updating, and/or storing employee insurance enrollment data and claims cost data for employee claims of one or more employer in consolidated database 54. Consolidated database 54 may provide ease of access to the insurance data for a particular employer and/or for a pool or network of employers. The consolidated database may enable, for example, efficient querying and insurance data report generation 106.

A number of implementations have been described. Nevertheless, it will be understood that various modifications may be made. Accordingly, other implementations are within the scope of the following claims.

What is claimed is:

1. A method comprising:
accessing employee insurance enrollment data;
accessing claims cost data for employee claims;
reconciling the claims cost data for employee claims with the employee insurance enrollment data; and
generating at least one insurance data report.

2. The method of claim 1, wherein the employee insurance enrollment data includes at least one of employee identification information, employee plan participation information, employee plan coverage information, individual employee stop loss amounts, and employee claims totals, and wherein accessing employee insurance enrollment data includes accessing employee insurance enrollment data according to one or more of employee gender, employee age, employee spouse information, employee dependant count, and employee insurance plan coverage information.

3. The method of claim 1, wherein the claims cost data for employee claims includes at least one of claimant identification information, submitted claim amounts, paid-out claim amounts and plan payment information.

4. The method of claim 1, wherein reconciling the claims cost data for employee claims with the employee insurance enrollment data includes:
comparing the employee insurance enrollment data with the claims cost data for employee claims;
determining whether the claims cost data for employee claims corresponds to the employee insurance enrollment data; and
if the claims cost data for employee claims does not correspond to the employee insurance enrollment data, notifying an employer of an insurance claims error.

5. The method of claim 1, further including:
calculating a predictive model for claims exposure based upon the employee insurance enrollment data and the claims cost data for employee claims.

6. The method of claim 1, further including:
accessing employer benefit plan data and employer location data; and
reconciling the claims cost data for employee claims with the employer benefit plan data and the employer location data.

7. The method of claim 1, further including:
auditing the claims cost data for employee claims.

8. The method of claim 1, further including:
accessing insurance trust administration data; and
reconciling the claims cost data for employee claims with the insurance trust administration data.

9. The method of claim 1, further including building a consolidated database containing the employee insurance enrollment data and the claims cost data for employee claims for a plurality of employees.

10. The method of claim 1, wherein the at least one insurance data report includes at least one of an employee insurance enrollment data report, a claims cost data report, a prefunding report, a claims exposure prediction report, a trust administration report, and a claim reconciliation report.

11. A computer program product residing on a computer readable medium having a plurality of instructions stored thereon which, when executed by a processor, cause the processor to perform operations comprising:
accessing employee insurance enrollment data;
accessing claims cost data for employee claims;
reconciling the claims cost data for employee claims with the employee insurance enrollment data; and
generating at least one insurance data report.

12. The computer program product of claim 11, wherein the employee insurance enrollment data includes at least one of employee identification information, employee plan participation information, employee plan coverage information, individual employee stop loss amounts, and employee claims totals, and wherein the instructions for accessing employee insurance enrollment data include instructions for accessing employee insurance enrollment data according to one or more of employee gender, employee age, employee spouse information, employee dependant count, and employee insurance plan coverage information.

13. The computer program product of claim 11, wherein the claims cost data for employee claims includes at least one of claimant identification information, submitted claim amounts, paid-out claim amounts and plan payment information.

14. The computer program product of claim 11, wherein the instructions for reconciling the claims cost data for employee claims with the employee insurance enrollment data include instructions for:
comparing the employee insurance enrollment data with the claims cost data for employee claims;
determining whether the claims cost data for employee claims corresponds to the employee insurance enrollment data; and
if the claims cost data for employee claims does not correspond to the employee insurance enrollment data, notifying an employer of an insurance claims error.

15. The computer program product of claim 11, further including instructions for:
calculating a predictive model for claims exposure based upon the employee insurance enrollment data and the claims cost data for employee claims

16. The computer program product of claim 11, further including instructions for:
accessing employer benefit plan data and employer location data; and
reconciling the claims cost data for employee claims with the employer benefit plan data and the employer location data.

17. The computer program product of claim 11, further including:
auditing the claims cost data for employee claims.

18. The computer program product of claim 11, further including instructions for:
accessing insurance trust administration data; and
reconciling the claims cost data for employee claims with the insurance trust administration data.

19. The computer program product of claim 11, further including instructions for building a consolidated database including the employee insurance enrollment data and the claims cost data for employee claims for a plurality of employees.

20. The computer program product of claim 11, wherein the at least one insurance data report includes at least one of an employee insurance enrollment data report, a claims cost data report, a prefunding report, a claims exposure prediction report, a trust administration report, and a claim reconciliation report.
